(19) United States
(12) Patent Application Publication
(10) Pub. No.: US 2019/0162307 A1
(43) Pub. Date: May 30, 2019

(54) Flat Gasket

(71) Applicant: Reinz-Dichtungs-GmbH, Neu-Ulm (DE)

(72) Inventors: Manuel Kamm, Neu-Ulm (DE); Wolfgang Kraus, Neu-Ulm (DE); Frank Pfau, Neu-Ulm (DE); Jochen Salzmann, Neu-Ulm (DE)

(21) Appl. No.: 16/205,956

(22) Filed: Nov. 30, 2018

(30) Foreign Application Priority Data
Nov. 30, 2017 (DE) 202017107285.1

(51) Int. Cl. F16J 15/10; F02F 11/00

(52) U.S. Cl. CPC F16J 15/104; F02F 11/002

(57) ABSTRACT

A flat gasket, as used for example as a cylinder head gasket in internal combustion engines may have a first layer and at least one through-opening which extends through all the layers of the flat gasket. The first layer may have a filling channel which extends in the layer plane to the through-opening in the first layer. A circumferential edge of the through-opening in the first layer may have a moulded-on seal which contains or is made of an elastomer and which runs around the through-opening and extends into the filling channel. In the uncompressed state of the flat gasket, the elastomeric filling of the filling channel may have in a region of the filling channel adjacent to the circumferential edge of the through-opening in the first layer, a region that is thickened perpendicular to the layer plane of the first layer.

The present invention relates to a flat gasket, as used for example as a cylinder head gasket in internal combustion engines.

Such flat gaskets usually have a plurality of through-openings for media. For example, cylinder head gaskets have combustion chamber openings and further through-openings for oil, cooling water and the like. For these through-openings, the purpose of the flat gasket is to prevent the medium from escaping in the layer plane of the flat gasket between the two components that are to be sealed with respect to one another by the flat gasket. To this end, often an elastomeric compound in particular is moulded onto one of the layers of the flat gasket around the circumferential edge of a through-opening, said compound providing a circumferential seal around the media through-opening between mutually adjacent layers of the flat gasket and between each of the components to be sealed and an adjacent layer of the flat gasket and thus overall between the two components to be sealed with respect to one another.

In order to mould said elastomeric seal onto the circumferential edge of the through-opening, a filling channel may be provided in the relevant layer of the flat gasket, said filling channel extending from an inlet region to the through-opening. Via this filling channel, the elastomer is conveyed from the inlet region to the circumferential edge of the media through-opening in the relevant layer. Once the elastomer has been introduced, the elastomer is cured and thus forms a sealing line along the circumferential edge of the media through-opening.

Alternatively, the elastomer may also be supplied to the circumferential edge of the layer in the flat gasket via a channel in the mould. In this case, however, a lot of elastomer is consumed in the dead space of the channel. Less elastomer is wasted in the case of a filling channel in the metal sheet of the layer.

One disadvantage of a filling channel within the layer, onto which the circumferential elastomeric seal is to be moulded, is that the moulded-on seal running around the media through-opening behaves differently in the region of the filling channel than in the regions not adjacent to the filling channel. This is because, when the elastomeric seal is compressed, the edge of the through-opening in the layer of the flat gasket, which layer is made of metal for example, supports the elastomeric seal. This shoulder, that is to say a steel shoulder in the case of a layer made of a steel sheet, is missing in the region of the filling channel, so that the elastomeric seal is not supported at that point and can be compressed to a greater extent.

Due to this inconsistent behaviour along the circumferential edge of the through-opening, the through-opening is not consistently and reliably sealed. In addition, defects in the moulded-on seal may occur in the region of the filling channel.

It is therefore an object of the present invention to provide a flat gasket with which reliable sealing is possible without any deformation or with only slight deformation of the sealing lip in the region of the filling channel, and which is also easy to manufacture.

This object is achieved by the flat gasket according to claim 1 and the gaskets mentioned in claim 16. Advantageous developments of the gaskets according to the invention will be given in the dependent claims.

Flat gaskets according to the invention are therefore, in particular, cylinder head gaskets, transmission control plates or other flat gaskets in the region of an internal combustion engine or the exhaust tract thereof.

The flat gasket according to the invention now has a first layer, in particular a metal first layer. Further layers adjacent to said first layer are possible. The flat gasket also has at least one through-opening which extends through all the layers of the flat gasket and which enables media to pass from one side of the flat gasket to the other side of the flat gasket.

The present invention also relates to a flat gasket which has a filling channel in the first layer in order to inject an elastomeric seal, via said channel, onto the circumferential edge of the through-opening in the first layer. An elastomeric filling is therefore located along the circumferential edge of the through-opening and in the filling channel of the gasket according to the invention, said elastomeric filling being formed in particular as a sealing lip along the circumferential edge.

Proceeding from such a flat gasket, in the uncompressed state, that is to say in the uninstalled or not yet fully installed state of the flat gasket, the elastomeric filling of the in the filling channel is thickened perpendicular to the layer plane of the first layer in a region located adjacent to or immediately adjacent to the circumferential edge of the through-opening in the first layer.

Due to the thickening of the elastomeric filling, the elastomeric filling in the filling channel is compressed to a greater extent in the thickened region when the flat gasket is installed between two components to be sealed. The thickened region is stiffened as a result. As a result of the compression, said thickened region not only bears against the components to be sealed but rather is pressed against said components, so that it can be displaced only by applying a great deal of force. In the region of the filling channel, therefore, the thickened region can replace the support provided by the shoulder of the circumferential edge of the first layer, in particular the steel shoulder in the case of a first metal layer, so that the compressibility of the sealing lip running around the circumferential edge is kept largely or completely constant along the circumferential edge. The compression of the elastomeric seal along the circumferential edge of the media through-opening is therefore made consistent, so that the sealing lip adjacent to the filling channel is deformed in the same way as the sealing lip outside of this region adjacent to the filling channel. The radius of the sealing lip from the shoulder of the through-opening in the first metal layer to the circumferential edge of the sealing lip at the through-opening is thus also made consistent.

The flat gasket according to the invention therefore makes it possible to produce the flat gasket in a manner that saves material and costs by using a filling channel that is located in the flat gasket, and at the same time makes it possible to ensure a sealing effect like that known from corresponding flat gaskets in which the filling channel runs in the mould.

Advantageously, in the uncompressed state of the flat gasket, the average thickness of the elastomer in the thickened region is 10 to 50% greater than the sum of the thicknesses of all the layers which have the filling channel in regions of the flat gasket adjacent to the thickened region. This means that, in the uncompressed state, the elastomer on the surfaces of the first layer or further layers which also have the filling channel protrudes by in each case 5 to 25% on each side if protruding on both sides or by a maximum of 50% on one side if protruding on one side.

Advantageously, the maximum extension of the thickened region on a straight line that is parallel to a tangent at the edge of the through-opening located at the end of the filling channel, that is to say transversely to the direction of extension of the filling channel, at half the height of the protrusion of the thickened region, in particular in the middle of the thickened region, is at least 0.5 mm, preferably at least 1.0 mm. As an alternative or in addition, this extension is at least one-quarter, preferably at least one-third, in particular at least one-half, of the extension of the filling channel on the same straight line, that is to say the width of the filling channel at this point.

This extension of the thickened region is determined here as the extension in which the region protrudes beyond the surfaces of the layers containing the filling channel.

In the uncompressed state of the flat gasket, the extension of the thickened region in the direction of the filling channel (direction of flow of the elastomer in the filling channel for filling purposes), in particular in the radial direction to the through-opening, is advantageously 0.8 to 5 times the extension of the thickened region transversely thereto.

Here, too, the extension can be the maximum extension or the extension at the middle of the thickened region relative to a direction perpendicular to this extension.

The thickness of the thickened region is advantageously ≥10% greater than the corresponding thickness of the elastomer in regions of the filling channel adjacent to the thickened region, in particular than the smallest thickness of the elastomer between the thickened region and the moulded-on seal along the through-opening. In other words, the height of the protrusion perpendicular to the layer plane of the first layer, that is to say the protrusion beyond the outer surfaces of the outermost layers adjacent to the protrusion, which contain the filling channel, is advantageously ≥10% of the corresponding thickness of the elastomer in regions of the filling channel adjacent to the thickened region.

Advantageously, in the uncompressed state of the flat gasket, the distance of the thickened region from the edge of the moulded-on seal pointing towards the through-opening and the width of the moulded-on seal has a ratio of between 1.1 and 5, preferably between 1.1 and 3.

Here, the distance of the thickened region from the edge of the moulded-on seal pointing towards the through-opening is determined in particular as the smallest distance between the edge of the moulded-on seal pointing towards the through-opening and a region of the thickened region that protrudes beyond the surface of the layers having the filling channel in the uncompressed state.

The width of the moulded-on seal, that is to say of the sealing profile that extends along the through-opening, can be determined as the extension of the region of the moulded-on seal which, in the uncompressed state, protrudes beyond the surface of the layers having the filling channel, in a direction perpendicular to the edge of the through-opening. If the sealing profile has regions which, in the uncompressed state of the flat gasket, have a smaller thickness than the total thickness of the layers having the filling channel, then the width of the moulded-on seal can be determined as the distance, measured perpendicular to the edge of the layer onto which the sealing profile is moulded, between the edge of said layer and the point closest to the opposite edge of the sealing profile at which the sealing profile still protrudes beyond the layers.

In advantageous developments, the filling channel has a narrowing which is formed in the layer plane. The thickened region is advantageously arranged in this narrowing. As a result, a further stiffening and thus supporting effect of the elastomer located in the filling channel is achieved. In a further advantageous development, the filling channel may have a web which extends in the layer plane or parallel to the layer plane. Said web may be attached to the layer edges of the filling channel on one side in the form of a freely projecting web or on both sides in the form of a bridge or may be extended in one piece from at least one layer in the filling channel, wherein the thickness of the web may be smaller than the rest of the thickness of the at least one layer. It is particularly advantageous if this web is arranged in the thickened region, in particular is at least partially or completely surrounded by the elastomer of the thickened region. Particularly if the web is embedded in the elastomer in the thickened region, it enhances the stiffening of the elastomer located in the filling channel and thus contributes to the supporting effect that the elastomer located in the filling channel has on the adjacent sealing lip.

A flat gasket according to the invention may have not just one through-opening configured in the manner outlined above, but also a plurality of such through-openings. In particular, it is possible that a plurality of, for example two, through-openings are connected to one another via a filling channel. In this case, it is possible that, in the case of a short filling channel, a single thickened region for two or more through-openings makes the compression behaviour of the sealing lip consistent. It is also possible, and in the case of longer filling channels advantageous, to provide a separate thickened region for each through-opening.

Some examples of flat gaskets according to the invention will be given below. Identical or similar reference signs will be used for identical or similar elements, and therefore the description thereof will not always be repeated. In the following examples, each example contains a number of optional developments of the present invention which may develop the present invention individually and independently or also in any combination with other optional developments of said example. It is also possible to develop the present flat gasket in combination with further optional developments from other examples.

In the figures:

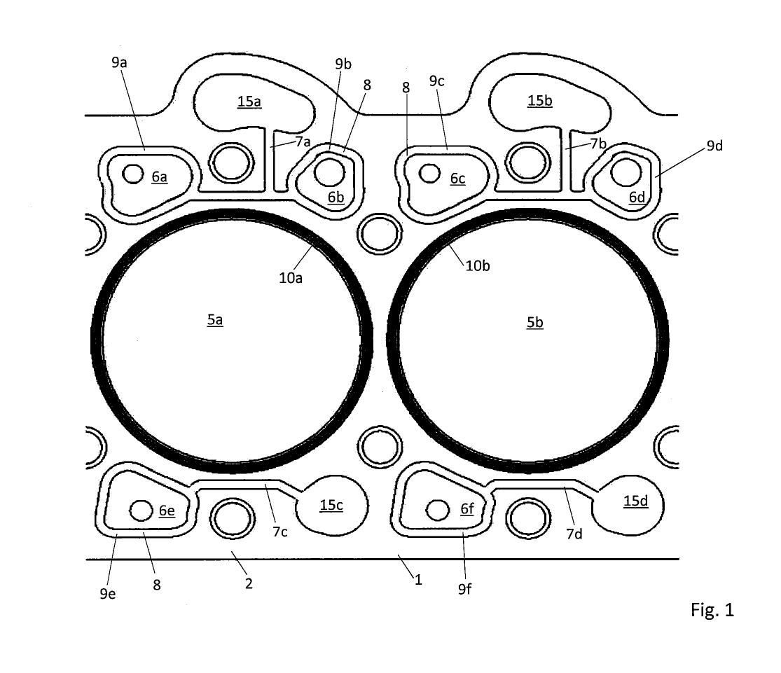

FIG. 1 shows a flat gasket according to the invention;

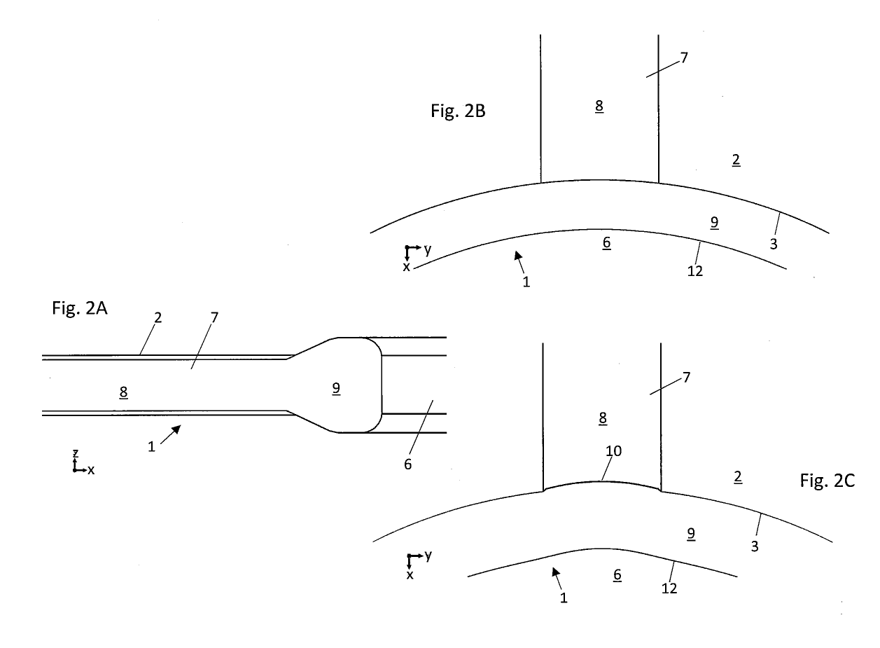

FIG. 2 shows a flat gasket according to the prior art; and

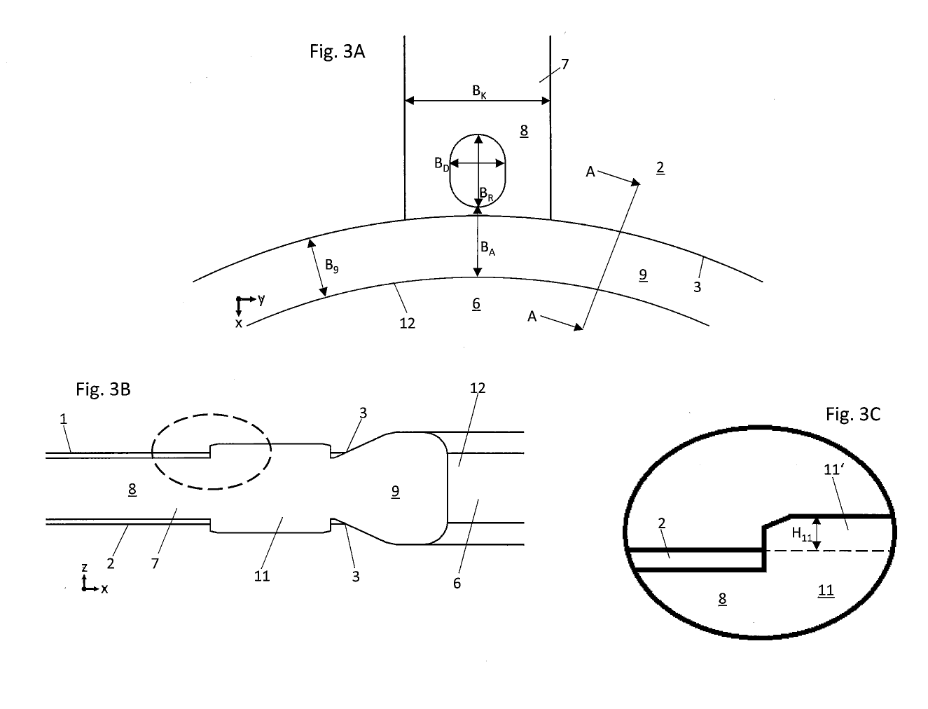

FIGS. 3-7 show examples of flat gaskets according to the invention in the portion around the transition between the filling channel and the through-opening to be sealed.

FIG. 1 shows a portion of a cylinder head gasket 1 in plan view. The flat gasket 1 is single-layered, comprising a first layer 2. Said layer 2 has a plurality of media through-openings, inter alia combustion chamber openings 5a, 5b, media through-openings 6a-6f, and a plurality of through-openings (not further denoted) for fastening means. Said additional media through-openings 6a-6f are, for example, through-openings for cooling water or engine oil between a cylinder head and a crankcase of an internal combustion engine.

The through-openings 6a-6f are connected to filling channels 7a-7d, wherein the filling channels for the media openings 6a and 6b, and respectively 6c and 6d, are connected to one another. Each of the filling channels ends in a cutout 15a-15d which serves as a filling opening for an elastomer when manufacturing the flat gasket 1.

FIG. 1 shows the flat gasket 1 in the finished state, in which the circumferential edges of the media through-opening 6a-6f are each surrounded by an elastomeric sealing lip 9a-9f. In addition, the filling channels 7a-7d and the filling openings 15a-15d are filled with the same elastomer 8 from which the sealing lips 9a-9d are made.

FIG. 2 shows in sub-figures A to C a portion from the transition between a filling channel 7 and a through-opening 6 of a flat gasket from the prior art. FIG. 2A shows a cross-section in the x-z plane. The filling channel 7 has an elastomeric filling 8, which has a smaller thickness than the layer 2. The elastomeric filling 8 then becomes thicker on the side of the circumferential edge of the layer 2 facing towards the through-opening 6, so as to form a sealing lip 9.

FIG. 2B shows a plan view of the same region of the first layer 2 of the flat gasket 1 in the uncompressed state. In this state, the width of the sealing lip 9 (in the x-y plane) running around the through-opening 6 is constant as seen in plan view. The width of the sealing lip 9 in the x-y plane does not change even at the transition to the elastomeric filling 8 in the filling channel 7.

FIG. 2C shows the same portion as FIG. 2B, but now after the flat gasket 1 has been compressed between two counterpart components. FIG. 2C therefore shows the installed, compressed flat gasket 1 without the counterpart components actually required for the compression. Due to the compression of the sealing lip 9, the latter is displaced into the filling channel 7 so that the circumferential edge 12 of the sealing lip 9 has a concave indentation 10. As a result, the sealing behaviour of the sealing lip 9 adjacent to the filling channel 7 differs from the sealing behaviour of the sealing lip 9 in those regions in which the sealing lip 9 is supported by the circumferential edge 3 of the layer 2.

FIG. 3 shows a flat gasket 1 according to the present invention in the portion around the region in which the filling channel 7 opens into the through-opening 6.

The flat gasket shown in FIG. 3 is configured like that shown in FIG. 2, but in the filling channel the elastomeric filling has a thickening 11 adjacent to the sealing lip 9. FIG. 3A shows a plan view of this thickening 11, FIG. 3B shows a cross-sectional view of the thickening 11 in the x-z plane, and FIG. 3C shows a portion of this region of the thickening in the x-z plane. The width of the thickening here is B_{D}, and the length thereof is B_{R}. The length B_{R} is determined in the direction of extension of the filling channel 7, and the width B_{D} is determined transversely to the direction of extension of the filling channel 7. The width of the filling channel is denoted B_{K}, the smallest distance between the circumferential edge 12 of the sealing lip 9 and the thickened region 11 is denoted B_{A}, and the width of the sealing lip 9 is denoted B₉. The length B_{R} and the width B_{D} of the thickening 11 is determined here between the points at which the thickening 11 in the uncompressed state protrudes beyond the layer 2 of the flat gasket 1. The height H11 of the protrusion 11′ of the thickening 11 is determined relative to the surface of the layer 2. In the present flat gasket shown in FIG. 3, B_{A}=1.95 mm, B_{D}=1.5 mm, B_{R}=2 mm, B_{K}=4 mm, B₉=1.7 mm and H₁₁=0.15 mm. In the case of multiple layers, the heights would be determined in each case relative to the surface of the outermost layer.

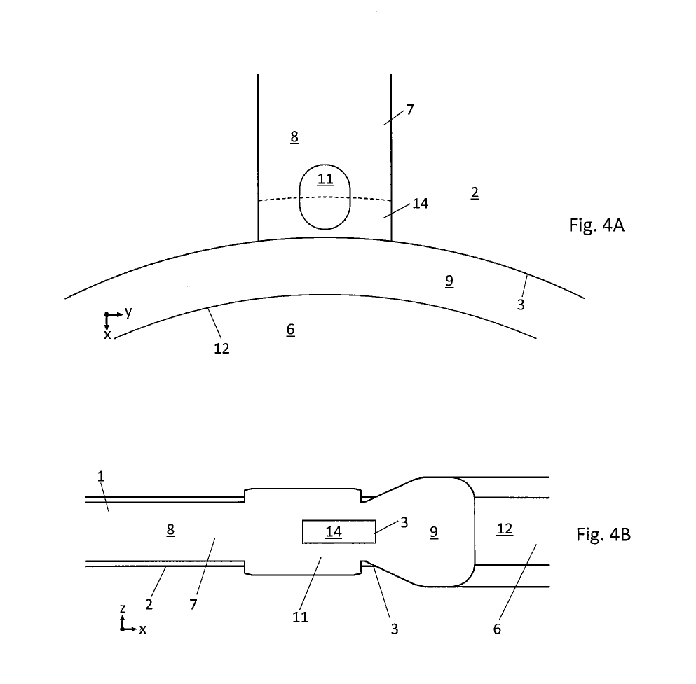

FIG. 4 shows a further inventive flat gasket according to the present invention. This is configured like the flat gasket shown in FIG. 3. In addition thereto, a web 14 is formed between the edges of the filling channel 7 that are laterally adjacent in the x-y layer plane, said web extending in the layer plane of the layer 2 between said two edges and being extended in one piece therefrom and having a reduced thickness. The web 14 may be made for example (in particular by stamping and embossing) from the material of the layer 2 at the time of producing the layer 2. The web 14 has a width, in the direction of extension of the filling channel 7, which is somewhat greater than the length of the thickening 11. The web 14 is arranged such that it extends in a direction parallel to the sealing lip 9, starting from the middle of the thickening 11 located in the direction of extension of the filling channel 7 and ending in the continuation of the circumferential edge of the layer 2 around the through-opening 6. The elastomeric compound 8 in the filling channel 7 is supported by this web 14 so that the combination of the web 14 and the thickening 11 of the elastomeric compound together prevent the sealing lip 9 from escaping in the direction of the filling channel 7 upon being compressed.

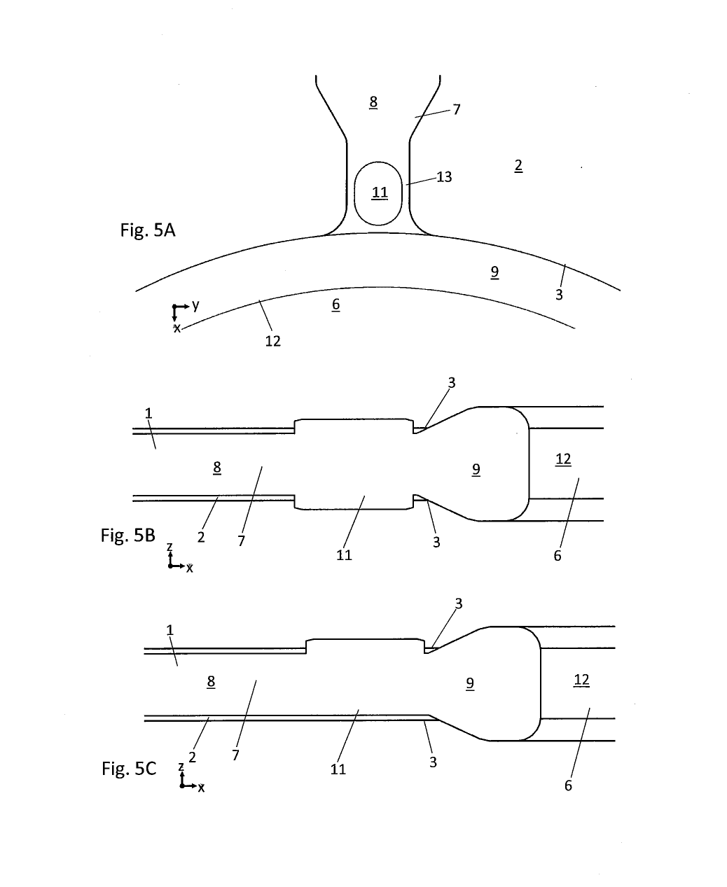

FIG. 5 shows a further flat gasket 1 according to the invention, similar to that in FIG. 3. In a manner differing from the embodiment in FIG. 3, the filling channel 7 has a narrowing 13, in which the thickening 11 is arranged in this example. By virtue of this narrowing 13, the escape space for the thickened region 11 is reduced and the thickened region 11 can thus serve even better as a support for the circumferential sealing lip 9.

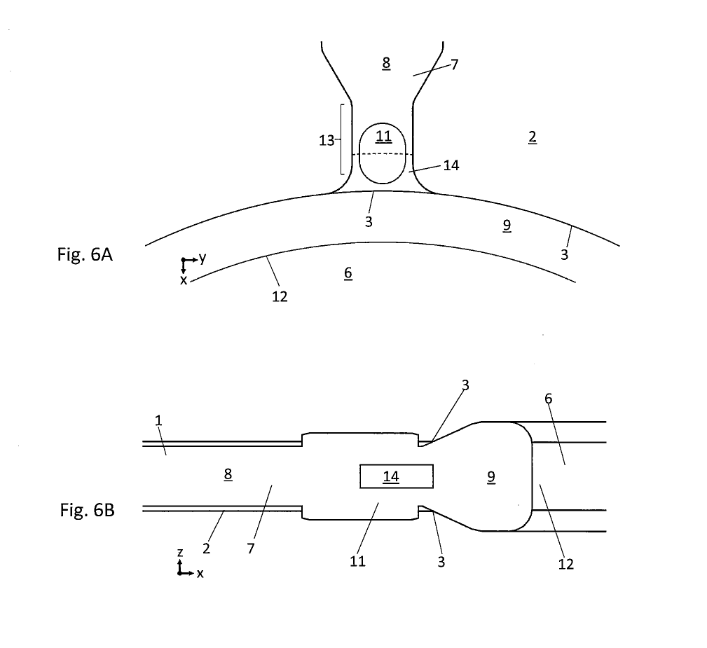

FIG. 6 shows a further embodiment of the flat gasket 1 according to the invention, which is configured like that in FIG. 3. The embodiment shown in FIG. 6 additionally has the web 14 of the embodiment in FIG. 4 and the narrowing 13 of the embodiment in FIG. 5, the web 14 also being arranged in the narrowing 13.

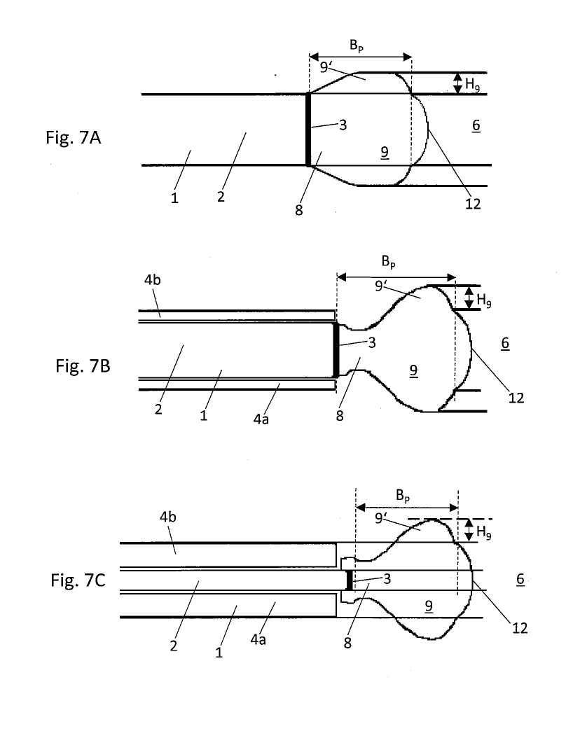

FIG. 7 shows, in sub-figures A, B and C, three further embodiments in cross-section through a region adjacent to the point at which the filling channel 7 transitions into the through-opening 6. In the illustrated cross-sections, Fig. A shows a single-layer gasket having a first layer 2 which has a circumferential elastomeric seal 9 of radial width B_{P}. The width B_{P} is determined here over the region in which the seal 9 protrudes beyond the surfaces of the first layer 2 in the uncompressed state. The edge 12 of the moulded-on seal 9 that points towards the through-opening 6 is rounded. As for the thickened region, the height can be determined as the height H₉ of the region 9′ of the seal 9 that protrudes beyond the metal layers, here beyond the uppermost metal layer 4b.

Sub-figure 7B shows a three-layer gasket having a first layer 2 as carrier layer and in each case a thinner, adjacent sealing layer 4a and 4b. The elastomeric seal 9 has a constriction between the layer 2 and the edge 12 thereof, so that displacement spaces are available for the elastomeric compound 8 when the flat gasket 1 is compressed. The width B_{P} of the elastomeric seal 9 is determined here between the edge of the first layer 3 and the point on the edge 12 of the elastomeric seal 9 at which the thickness of the elastomeric seal 9 is equal to the total thickness of the layers 2, 4a and 4b of the flat gasket 1.

FIG. 7C likewise shows a three-layer flat gasket having a first carrier layer 2 and adjacent further thinner layers 4a and 4b as further functional layers. Here, the layer 2 protrudes, in the direction of the through-opening 6, beyond the circumferential edges of the layers 4a and 4b running around the through-opening 6. This makes it possible for the elastomeric seal 9 not just to be moulded onto the circumferential edge of the layer 2 around the through-opening 6, but instead the elastomeric compound 2 can be injected around this circumferential edge 3 of the layer 2 such that it also runs partially onto the surfaces thereof and thus improves the bonding of the elastomeric seal 9 to the layer 2. Here, too, the width B_{P} is measured from the edge of the layer 3, that is to say from the steel shoulder.

1-16. (canceled)

17. A flat gasket having a first layer and at least one through-opening which extends through all the layers of the flat gasket, wherein the first layer has a filling channel which extends in the layer plane to the through-opening in the first,
wherein the circumferential edge of the through-opening in the first layer has a moulded-on seal which contains or is made of an elastomer and which runs around the through-opening and extends into the filling channel,
wherein
in an uncompressed state of the flat gasket the elastomeric filling of the filling channel has, in a region of the filling channel adjacent to the circumferential edge of the through-opening in the first layer a region that is thickened perpendicular to the layer plane of the first layer.

18. The flat gasket according to claim 17, wherein, in the uncompressed state of the flat gasket, the maximum or average thickness of the elastomer in the thickened region is 10 to 50% greater than the sum of the thicknesses of all the layers which have the filling channel in regions of the flat gasket adjacent to the thickened region.

19. The flat gasket according to claim 17, wherein, in the uncompressed state of the flat gasket, a maximum extension of the thickened region on a straight line that is parallel to a tangent at the edge of the through-opening located at the end of the filling channel, at half a height of the protrusion of the thickened region, is at least 0.5 mm.

20. The flat gasket according to claim 17 wherein, in the uncompressed state of the flat gasket, a maximum extension of the thickened region on a straight line that is parallel to a tangent at the edge of the through-opening located at the end of the filling channel, at half a height of the protrusion of the thickened region, is at least ¼, of an extension of the filling channel on the same straight line.

21. The flat gasket according to claim 19, wherein in the uncompressed state of the flat gasket, an extension of the thickened region in the radial direction to the through-opening is between 0.8 and 5 times the extension of the thickened region in a straight line that is parallel to a tangent at the edge of the through-opening located at the end of the filling channel, at half the height of the protrusion of the thickened region.

22. The flat gasket according to claim 21, wherein the extension of the thickened region is the maximum extension or the extension at the middle of the thickened region relative to a direction perpendicular to this extension.

23. The flat gasket according to claim 19, wherein said height of the protrusion is the protrusion of the thickened region beyond the outer surface of the outermost layer adjacent to the protrusion, determined perpendicular to the direction of extension of the filling channel and perpendicular to the layer plane of the first layer.

24. The flat gasket according to claim 17, wherein in the uncompressed state of the flat gasket, the maximum thickness of the elastomer in the thickened region is ≥10% greater than the thickness of the elastomer in regions of the filling channel adjacent to the thickened region, including the smallest thickness of the elastomer between the thickened region and the moulded-on seal along the through-opening.

25. The flat gasket according to claim 17, wherein in the uncompressed state of the flat gasket, a maximum thickness of the elastomer in the thickened region is greater than the sum of the thicknesses of all the layers, or of all the layers in which the filling channel is formed, in regions of the flat gasket adjacent to the thickened region.

26. The flat gasket according to claim 17, wherein in the uncompressed state of the flat gasket, a thickness of the elastomer in the thickened region is smaller than the thickness of the elastomer in the moulded-on seal along the through-opening.

27. The flat gasket according to claim 17, wherein in the uncompressed state of the flat gasket, the ratio of a distance of the thickened region from an edge of a moulded-on seal pointing towards the through-opening to a width of the moulded-on seal along the through-opening is 1.1 to 5, the distance being the smallest distance between a region of the moulded-on seal along the through-opening that protrudes beyond the surface of the first layer in the uncompressed state and a region of the thickened region that protrudes beyond the surface of the first layer in the uncompressed state.

28. The flat gasket according to claim 17, wherein the filling channel has a narrowing, in which the thickened region is arranged.

29. The flat gasket according to claim 17, wherein in that the filling channel has a web which extends in the layer plane of the first layer and which extends between the two sides of the filling channel.

30. The flat gasket according to claim 17, wherein the web is attached only at one side to one of the sides of the filling channel, to provide a free end of the web.

31. The flat gasket according to claim 30, wherein the web is arranged such that the elastomer in the thickened region at least partially or completely surrounds the web.
